(19) United States
(12) Patent Application Publication
(10) Pub. No.: US 2003/0210612 A1
(43) Pub. Date: Nov. 13, 2003

(54) Sports control device for game clock or whistle

(76) Inventor: Max Meier Stern, Lake Forest, CA (US)

Correspondence Address: MAX M. STERN, 24284 ONTARIO LANE, LAKE FOREST, CA, 92630, US

(21) Appl. No.: 10/139,538

(22) Filed: May 7, 2002

(51) Int. Cl. G04F 8/00; G04F 10/00

(52) U.S. Cl. 368/110

(57) ABSTRACT

A device used at a sports event, by an official, that when activated can create a whistle sound, with instant transmission of a coded signal to compatible receivers, located in one or more timepieces, to start or stop this crucial piece of equipment, immediately, accurately and without outside interference, thereby indicating the time status of the game being officiated.

### BACKGROUND OF THE INVENTION

1. Field of the Invention

This Invention pertains to a hand held electronically activated transmitter with optional whistle sound capabilities, used at various sports events, by an official, when activated, transmits an electronically coded signal, which instantly will start or stop one or more time keeping clocks or wrist watches at that sports event.

2. Description of the Prior Art

An official to indicate the goings on, on a field of play for many years has used a whistle sound at a sports event. The official or officials also wear a watch to keep track of time; a watch or clock that is used to keep the time outside of the field of play sometimes backs this up, and allows those who have an interest to see the time available.

In the case of Schneider (U.S. Pat. No. 6,181,236) a conventional mouth assisted whistle sound whose air is required to complete the sequence from initiation to completion and thereby is used to generate an electronic impulse to a transmitter. The device requires air from the mouth to function, while my device is hand held, hand operated, no air is required, with the same button being used to complete the circuit to sound the whistle while sending the coded signal from the transmitter to a compatible receiver in a game timepiece.

The device of Costabile (U.S. Pat. No. 5,293,354) produces a signal that ultimately stops a clock. The whistle sound is separate from the radio transmitter and this is required to be carried by this sports official or another official, with the transmitter being triggered by the actual whistle sound, whose signal is then sent to stop a clock at a sports event. My device when activated causes a whistle sound electronically, and at the precise same time the activation for the whistle is pushed, the circuit to the transmitter in the same handle housing is closed, thereby sending a coded signal to a receiver in the clock. This action causes the clock to start or stop.

The invention of Wilson (U.S. Pat. No. 4,861,305) is not intended for use in sport, but to improve the learning skills of a child.

When it comes to the device of Masuyama (U.S. Pat. No. 4,098,068) a whistle sound is produced to signify the time. This does not stop or start a clock nor is intended for use in sports.

In the case of Abbott (U.S. Pat. No. 3,651,507) an input stimulus means is required to be activated, such as a sensor. In an example that is given air is required to stimulate the transmitter-air switch combination. My invention to be activated is carried out by a circuit being completed by pressing a button, and no air is involved nor any sensor at the point of activation to the transmitter, before a transmission is forwarded to a game timepiece in code.

In this device of mine, with whistle and transmitter are in one housing that fits into the palm of the hand. This hand held housing with whistle and transmitter capabilities, can be activated by the same button that causes the whistle sound and transmitter to send out a coded signal. The whistle sound does not activate the transmitter. More than one device can be used on a single sports field. This device of mine increases the accuracy of the time or clock for stopping instantly as the signal is received immediately to start or stop, of the field timepieces or the wristwatch worn by the official.

The use of a single or multiple hand held housing, with whistles and transmitters will allow one or more receivers to respond to a signal, is achieved by using a coded signal that is compatible only among those hand held whistles with transmitters and the number of clocks or watches that are encompassed in this group as a unit and set up to receive that coded signal.

This means will also allow more than one sports event to take place at the same time and venue, without a conflict of the clock being inadvertently stopped. This method also protects an outsider from interfering with the accuracy of the clock or watch as the signal is sent in code.

To start play after the game has been held up by an official, and the game has to be restarted, with the exception of a designated break or at the games end, this can be achieved, by pushing the same button that activated the whistle sound with transmission or by the second button which allows only the coded transmitted signal to be sent to the receiver without any whistle sound whereby the game can be restarted. This depends on the decision of the official or the needs of the game, that are being played, or the action that the official has resorted to, to satisfy the criteria of that game.

None of the devices mentioned have any safety feature incorporated, that a transmission of the signal cannot be sent to activate or deactivate the clock or watch inadvertently.

This device of mine, while the official is running, can be passed from one hand to another or even given to another official, for activation as it fits completely into the palm of the closed hand, with all of the components in or on the one housing. The signal to activate the transmitter is activated by the same button that causes the circuit for the whistle sound to be emitted and completed. The closing of this circuit, can start or stop the clock at a sports event by transmitting a coded signal to a receiver that controls the mechanism of the game timepiece, which can have more than one hand held device to one or more clocks or watches that have been calibrated to be compatible only within that group of units.

Non of the previous inventions are capable of a singular activation means of controlling multiple clocks or watches, nor of multiple activation means of controlling a single game clock or watch, nor of multiple activation means for controlling multiple game clocks or watches.

### SUMMARY OF THE INVENTION

This Invention is a means with a hand held device, fitting into the palm of the hand, housing all of the electronics on or inside the casing, to create an optional whistle sound when activated, while simultaneously sending a coded signal from a transmitter to a compatible receiver, set up to receive the signal that is housed inside a clock or watch, at a sports event whereby the clock or watch is started or stopped instantly, by an official.

The housing means that fits into the palm of the hand has a speaker at one end, connected with the first of two switches placed in line close to the top of the housing.

The higher up of the two switches has a double push actions means to activate. The reason for this being that it should not be able to be activated by accident. When this button is pushed firmly, it will pass through it's safety faze and then the circuit will be completed, thereby allowing the whistle sound to be emitted from the speaker as well as the circuit of the transmitter to be closed and a coded signal will be sent instantly to the compatible receiver in the clock or watch, thereby causing the game time to start or stop. The receiver is integral with the mechanics of the clock or watch and controls both the starting and stopping functions of the game timepiece.

The sports event to start might require that the whistle sound should be heard, which means that the top button is normally pushed to activate the sound and the transmission to the game timepiece is sent. The means to stop the clock with the whistle sound is achieved by pushing the same button, whereby the transmission is forwarded to the receiver in the timepiece and it stops.

A scenario at the game can take place during or occur when the game is stopped, that the sports official might want to deactivate or activate the watch or clock without sound. This means has been provided by a second button just below the first, that has been slightly recessed in the housing so that it does not interfere with or can be pushed accidentally, yet uses the same transmitter when activated but circumvents, when closed, the circuit that provides the whistle sound, thereby the timepiece controls are activated instantly but silently.

Accordingly, the main object of this invention is a simple means to produce from components that are out in the marketplace, using a hand held housing, on activation, an instant transmission of a coded signal to a receiver, to start or stop a clock or watch that governs the playing time at a sports event, controlled by an official involved in the game, with or without the whistle sound. The complete device can be carried from the strap at the end of the housing around the wrist or from a longer strap around the neck.

This device can also overcome another shortcoming at a sports event as some participants and spectators cannot hear the official blowing the whistle. This is achieved by having strategically located speakers, at the game, that have compatible receivers installed, that will respond to the coded incoming signals, from the activation of the transmission, by causing a whistle sound to be heard loud and clear, no matter which button is pressed on the handle housing.

These and other objects of the invention will become more apparent upon reading the description of the preferred embodiments taken with the drawings appended hereto. The scope and protection sought by the inventor may be gleamed from a reading of the claims that conclude the specifications.

### DESCRIPTION OF THE DRAWINGS

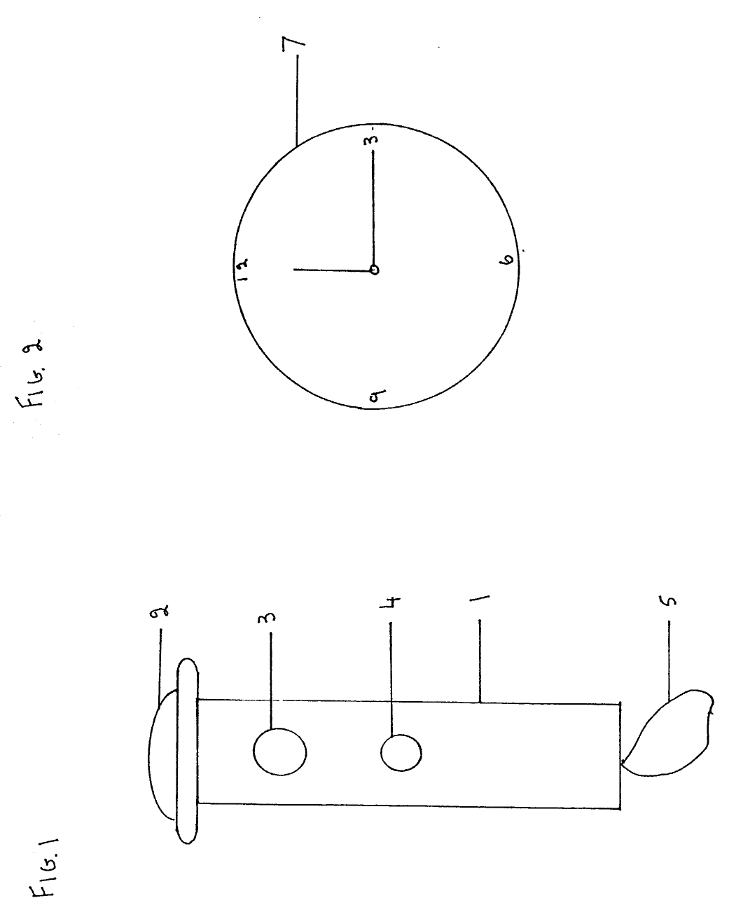

Drawing FIG. 1 is an outside front view of the housing showing the placement of the speaker, buttons for activation and strap for carrying on the opposite end of the housing.

Drawing FIG. 2 is a front view of the clock or watch showing just the face.

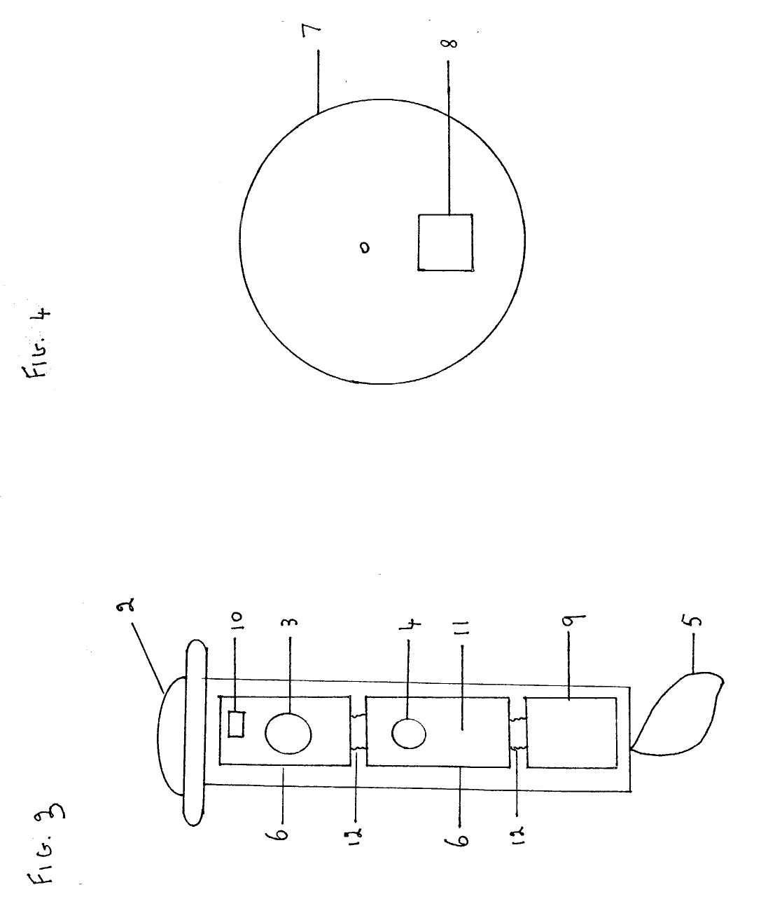

Drawing FIG. 3 is a cut away inside view of the housing showing the placement of the components, with a battery as the power source.

Drawing FIG. 4 is a front view of the clock or watch without the face. The receiver and control board are visible. The power source is not shown as it could be operated by battery or electricity.

### NUMERALS OF THE EMBODIMENT

1) housing

2) speaker

3) button with transmission and sound

4) activation without sound

5) strap

6) control board

7) clock or watch

8) receiver with control board

9) battery

10) whistle sounding chip

11) transmitter

12) connections

### DESCRIPTION OF THE DRAWINGS

FIG. (1) clearly shows the components that are incorporated on the housing (1) that are required to activate the integral mechanism, thereby creating a whistle sound, while at the same instant sending a coded signal to a compatibly equipped receiver. The housing (1) has at one end of the handle a speaker (2) from which the whistle sound is heard. The top button (3) when pushed firmly, because of the safety feature built in, so that it should not be activated accidentally, then causes not only a whistle sound but also a coded transmitted signal to be forwarded instantly to a compatible receiver in the watch or clock.

The housing (1) also has another button (4) just below the other button (3) that is slightly recessed in the housing (1) to prevent accidental activation while being used by an official.

This button (4) when activated to start or stop a game timepiece does not create any sound but is transmitted in code in a silent mode, whereby only the signal is sent. This is achieved by circumventing the whistle circuit, so no audible sound is heard. The transmitter still sends the signal only to those compatibly set up receivers.

At the other end of the housing (1) away from the speaker (2) is the strap (5) or cord, that allows the activation means to be carried or worn around the neck or on the wrist.

More than one housing (1) with these electronic components once setup, can work at a single game as long as they are programmed to work within that group of units. This has been accomplished in case more than one official uses the activation means or in case there is more than one field close to each other.

The receivers have been setup in each timepiece to accept this coded signal only and one or more receivers can be programmed that will be compatible in the same unit group, to receive the coded signal.

FIG. 2 (2) shows the outside face of the wristwatch or clock (7) that can be worn by an official, instead of them having to actually manually operate the watch on their body, or game the clock (7) that will be used as the timepiece, with the receiver imbedded inside, that will be programmed to receive the coded signal and perform the task of time control. More than one timepiece (7) can be utilized but they all have to be set to receive the same coded transmission within that group, to start or stop the game watch or clock, when called upon to perform that function. The signal is received in code as a safety feature, to hopefully eliminate outside interference, as well as have more activation and receiving means in a secure group.

FIG. (3) shows the layout of the workings inside the housing (1) with the speaker (2) and the strap (5) at each end. The power (9) is a battery with many connections (12) to the various electronic components. The activation with sound button (3) when double pushed causes the circuit to be completed and the control board (6) that has the whistle chip (10) means embedded inside and can be programmed to be setup to work within a group of units, that has the ability to send immediately a coded transmitted signal from the ransmitter (11) that is placed on the lower of the control boards (6) to the receiver inside the wrist watch or game clock, whereby the audible whistle sound and instant coded signal are heard and sent.

The no sound activation button (4) that is slightly recessed in the housing (1) has been so installed in an effort to overcome any accidental pressing of the activation means while the official is running or concentrating on the game. When this button (4) is pressed the circuit is closed for the coded transmission only, with no sound and the lower of the control boards (6) is used to perform this task of sending the coded signal to start or stop the timepiece.

FIG. (4) has the face of the wristwatch or clock (7) removed showing the receiver (8) with the control board. The receiver with control board (8) accepts the coded signal only and then performs the tasks that have been programmed into the board, whereby the timepiece (7) is started or stopped. The control board (8) can also be programmed so that more than one transmitter can be used at the same time, that will receive only that coded signal from compatible transmitters, that are within that group setup. This allows for more than one timepiece (7) to be active and controlled in that sports event.

What is claimed:

1) At a sports event, a device used by an official, that simultaneously creates a whistle sound, with instant transmission of a coded signal to a receiver, thereby controlling the start or stop functions in the game watch or clock.

2) The activation means for the device to control the time piece or pieces to be used at the sports event, has a second activation means, so that should the official only want to send the coded transmission he/she has that option, with no sound.

3) The device of claim (1) when activated sends the transmitted signal in code.
a) The receiver has to be setup to receive this coded signal and thereby start or stop the timepiece.
b) This coded feature has been included so that the integrity of the transmission is secure from outside interference.

4) The device of claim (3) can have similar devices that have been programmed to be compatible when activated, so that they will work within that group of units, to send the coded signal to a single receiver.
a) More than one timepiece with receiver can also be configured to receive the coded signal from a single activation means.
b) More than one time piece can be configured to receive the coded signal from many devices to start or stop the game watch or clock.

5) The device of claim (1) has safety features incorporated into both of the activation means on the housing, so that no signal or sound can be inadvertently triggered.
a) The button for sound and transmission activation has a two-stage button that requires, the button to be pushed firmly before the circuit is completed.
b) The transmitter only button activation means has been slightly recessed.
